(19) United States
(12) Patent Application Publication
(10) Pub. No.: US 2019/0190100 A1
(43) Pub. Date: Jun. 20, 2019

(54) HEAT DISSIPATION DEVICE FOR VEHICLE BATTERY

(71) Applicant: NATIONAL CHUNG SHAN INSTITUTE OF SCIENCE AND TECHNOLOGY, Taoyuan City (TW)

(72) Inventors: JING-HONG CHEN, TAOYUAN CITY (TW); WEI-YUAN LIAO, TAOYUAN CITY (TW); YU-HUNG CHEN, TAOYUAN CITY (TW); CHING-HSIANG WANG, TAOYUAN CITY (TW); CHIA-CHEN WU, TAOYUAN CITY (TW)

(21) Appl. No.: 15/841,815

(22) Filed: Dec. 14, 2017

(51) Int. Cl. H01M 10/6556; B60R 16/04; H01M 2/10; F28D 15/02; F24F 12/00

(52) U.S. Cl. CPC H01M 10/6556; B60R 16/04; F28D 2021/0038; F28D 15/02; F24F 12/003; H01M 2/1083

(57) ABSTRACT

A heat dissipation device for a vehicle battery includes a box for receiving therein at least a vehicle battery; an upper lid disposed above the box and separated from the box by a waterproof plastic sheet; a microspray heat dissipation pipe disposed on a side of the box and having at least a microspray nozzle in communication with an inside of the box; and at least a non-return exhaust duct disposed on an opposing side of the box and in communication with the inside of the box.

### FIELD OF THE INVENTION

The present invention relates to electric vehicle technology and, more particularly, to a heat dissipation device for a vehicle battery applicable to electric buses.

### BACKGROUND OF THE INVENTION

Conventional power packs for powering electronic products usually include a battery cell enclosed in a casing which provides physical protection, if any, to the battery cell. Power supplied by conventional power packs depends on how much electrical energy is stored in the battery cell, leading to short power supply duration of conventional power packs. Voltages of electronic products are seldom higher than 24V; hence, applications of conventional power packs are restricted to 3C products as well as charging and discharging emergency light-current systems for use with automotive alternators. Voltages higher than 48V are common only among power packs of a few green mobile power storage systems and electric buses, and the power packs are usually mounted on stationary storage racks or distributed uniformly in the vehicle, not only providing limited protection to battery modules or power packs, but also posing a risk of electric shock by generating an instantaneous or transient high voltage of 600˜700V as soon as the electric buses start to be electrically driven. Furthermore, if the battery modules lack a quick-removal maintenance mechanism but get damaged, the power packs must be entirely removed in order to carry out maintenance, which is time-consuming and laborious. Moreover, the power packs have a high chance of failure when not waterproof and dustproof.

Most issued invention and utility model patents which claim a power pack are directed to a rechargeable lithium battery power pack or a mobile rechargeable lithium iron power pack for use with 3C products, such as computers, in a manner that the rechargeable lithium battery power pack or the mobile rechargeable lithium iron power pack is mounted on a stationary battery rack when it comes to mobile power storage systems or electric buses. None of the aforesaid power packs comes with a battery heat dissipation device or provides dustproof and waterproof (IP66 or better) protection to the battery modules.

Conventional heavy-duty power pack heat dissipation devices work by water jackets or water routes and thus have drawbacks as follows: rendering the power packs heavy, and requiring pumps and flow channels to the detriment of space efficiency and energy efficiency. Hence, the prior art fails to meet the demand for energy saving, carbon reduction, green energy, and environmental protection.

### SUMMARY OF THE INVENTION

In view of the aforesaid drawbacks of the prior art, it is an objective of the present invention to provide a heat dissipation device for a vehicle battery to receive the battery of an electric bus and dissipate heat from the battery. The heat dissipation device for a vehicle battery according to the present invention comprises a box, an upper lid and a waterproof plastic sheet disposed airtightly therebetween to provide a waterproof, dustproof battery-receiving environment (IP66 or better), thereby preventing intrusion of moisture which may otherwise cause the battery to rust or develop a short circuit. The heat dissipation device for a vehicle battery according to the present invention has a modularized, quick-removal box whereby the heat dissipation device for a vehicle battery can be quickly mounted on and demounted from the electric bus so as for the battery thereof to be changed quickly.

The present invention provides a heat dissipation device for a vehicle battery, comprising: a box for receiving therein at least a vehicle battery; an upper lid disposed above the box and separated from the box by a waterproof plastic sheet; a microspray heat dissipation pipe disposed on a side of the box and having at least a microspray nozzle in communication with an inside of the box; and at least a non-return exhaust duct disposed on an opposing side of the box and in communication with the inside of the box.

In an embodiment of the present invention, the microspray heat dissipation pipe comprises: a condensation pipe having the at least a microspray nozzle in communication with the inside of the box and having an end in communication with a cool air generation source; a temperature-controlled throttle valve disposed between the condensation pipe and the cool air generation source; and an enclosing case for enclosing the condensation pipe. The condensation pipe is made of copper. The dehumidifying unit takes in moisture of the cool air with activated carbon.

In an embodiment of the present invention, the cool air generation source is the vehicle's built-in air conditioning system whereby the cool air is introduced into the microspray heat dissipation pipe. Alternatively, the cool air generation source is a standalone air conditioning unit which is an air conditioning unit (such as a small air conditioner) dedicated to the heat dissipation device for a vehicle battery to dispense with the need for the cool air from the vehicle's built-in air conditioning system.

In an embodiment of the present invention, the temperature-controlled throttle valve regulates the flow rate of the cool air admitted to the box in accordance with the temperature within the box and the battery's temperature. A temperature sensor is disposed in the box to capture battery temperature signals from the battery's built-in battery management system (BMS) so as to control how the temperature-controlled throttle valve regulates the flow rate of the cool air.

In an embodiment of the present invention, the heat dissipation device for a vehicle battery further comprises a dehumidifying unit disposed between the temperature-controlled throttle valve and the cool air generation source to take in moisture of the cool air with activated carbon and thus prevent moisture intrusion which might otherwise cause the battery to rust or develop a short circuit.

In an embodiment of the present invention, the non-return exhaust duct comprises: an exhaust pipe having an end in communication with the inside of the box and another end provided with a non-return exhaust vent; and an exhaust fan disposed in the exhaust pipe and positioned proximate to the non-return exhaust vent to remove air from the box, so as to discharge the air by the non-return exhaust vent. The non-return exhaust vent prevents external air (which might carry moisture and dust) from entering the box through the non-return exhaust duct to contaminate the battery in the box.

In an embodiment of the present invention, at least one hanging-fixing element is disposed on the outer wall surface of the box to hang the heat dissipation device for a vehicle battery onto the electric bus and facilitate demounting the heat dissipation device for a vehicle battery from the electric bus for a repair thereof and changing the battery. The at least one hanging-fixing element is a ring bolt screwed to the outer wall surface of the box or an equivalent of the ring bolt. In a variant embodiment, a short hole is disposed on the outer wall surface of the box, without reducing the mechanical strength of the box, to hang the heat dissipation device for a vehicle battery onto the electric bus and facilitate demounting the heat dissipation device for a vehicle battery from the electric bus for a repair thereof and changing the battery.

In an embodiment of the present invention, a waterproof, dustproof protective element is disposed between the box and the microspray heat dissipation pipe and between the box and the non-return exhaust duct, which together with a waterproof plastic sheet disposed airtightly between the upper lid and the box, renders the heat dissipation device for a vehicle battery waterproof and dustproof. In an embodiment of the present invention, the heat dissipation device for a vehicle battery is dustproof and waterproof (IP66 or better) to meet the driving requirements of the electric bus.

The above summary, the detailed description below, and the accompanying drawings further explain the technical means and measures taken to achieve predetermined objectives of the present invention and the effects thereof. The other objectives and advantages of the present invention are explained below and illustrated with the accompanying drawings.

### BRIEF DESCRIPTION OF THE DRAWINGS

FIG. 1 is an exploded view of a heat dissipation device for a vehicle battery according to an embodiment of the present invention;

FIG. 2 is a schematic view of the assembled heat dissipation device for a vehicle battery according to an embodiment of the present invention;

FIG. 3 is a schematic view of a disassembled microspray heat dissipation pipe according to an embodiment of the present invention; and

FIG. 4 is a schematic view of a disassembled non-return exhaust duct according to an embodiment of the present invention.

### DETAILED DESCRIPTION OF THE PREFERRED EMBODIMENTS

Implementation of the present invention is hereunder illustrated by a specific embodiment. Persons skilled in the art can easily understand other advantages and effects of the present invention by referring to the disclosure contained in the specification.

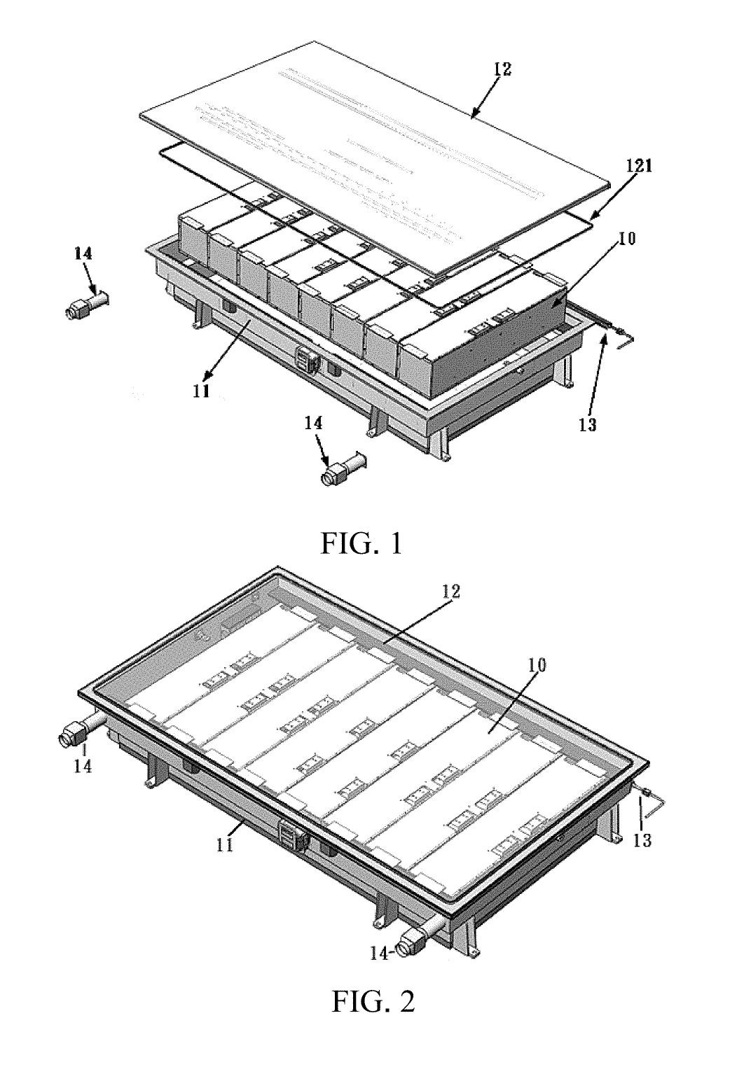

Referring to FIG. 1 and FIG. 2, there are shown schematic views of a heat dissipation device, assembled and disassembled, for a vehicle battery according to an embodiment of the present invention, respectively. As shown in the diagrams, the heat dissipation device for a vehicle battery comprises: a box 11 for receiving therein a plurality of vehicle batteries 10; an upper lid 12 disposed above the box 11 and separated from the box 11 by a waterproof plastic sheet 121; a microspray heat dissipation pipe 13 disposed on one side of the box 11; and a non-return exhaust duct 14 disposed on the other side of the microspray heat dissipation pipe 13 and in communication with the inside of the box 11. The box 11 is made of a thermally conductive material and is in direct contact with the battery to transfer heat from the battery to the box 11, allowing the heat to be dissipated through the large surface area of the box 11.

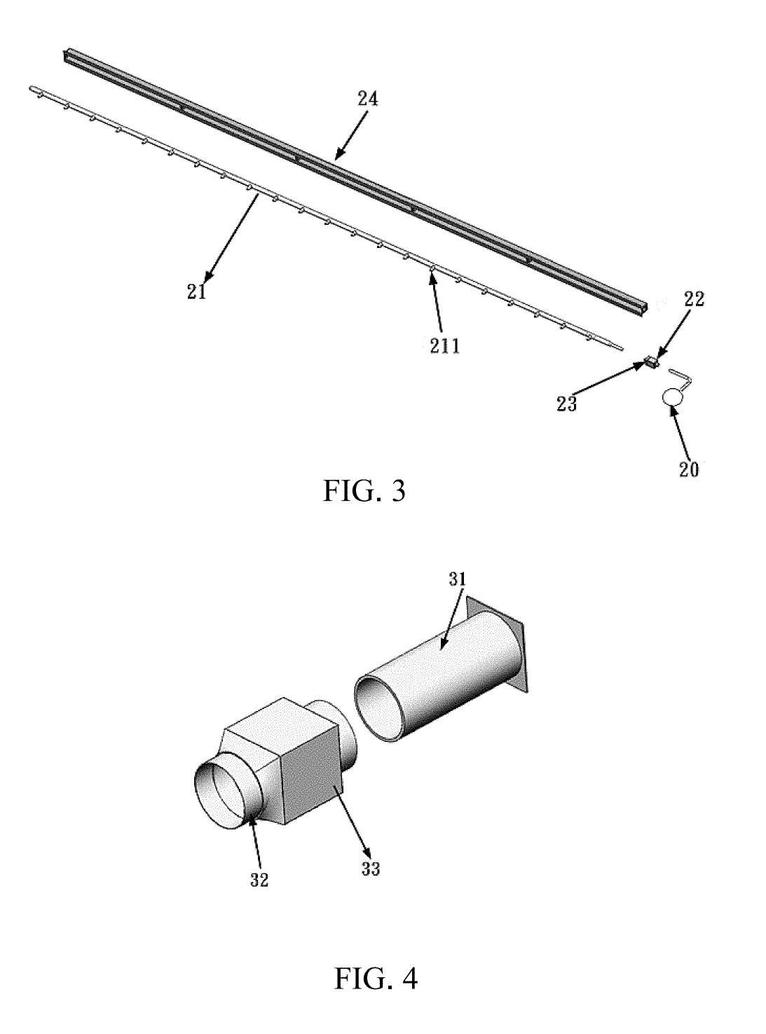

FIG. 3 is a schematic view of the disassembled microspray heat dissipation pipe 13 according to an embodiment of the present invention. As shown in the diagram, the microspray heat dissipation pipe 13 comprises: a copper condensation pipe 21 which has a plurality of microspray nozzles 211 and has one end in communication with a cool air generation source 20; a dehumidifying unit 22 and a temperature-controlled throttle valve 23 which are disposed between the cool air generation source 20 and the condensation pipe 21; and an enclosing case 24 for enclosing and protecting the condensation pipe 21. The microspray heat dissipation pipe 13 delivers cool air to the box 11 by the microspray nozzles 211 to cool down the battery in the box 11. The cool air is either from a built-in air conditioning system of the bus or from a standalone air conditioning device as needed. In this embodiment, the dehumidifying unit 22 is a drying chamber filled with activated carbon to take in moisture of the cool air and is integrally coupled to the temperature-controlled throttle valve 23. In a variant embodiment, a dehumidifying apparatus is provided instead, without giving considerations to energy efficiency and cost control (activated carbon is generally is the cheapest, easiest option.)

FIG. 4 is a schematic view of the disassembled non-return exhaust duct 14 according to an embodiment of the present invention. As shown in the diagram, the non-return exhaust duct 14 comprises an exhaust pipe 31, a non-return exhaust vent 32 and an exhaust fan 33. As mentioned before, the microspray heat dissipation pipe 13 delivers cool air to the box 11 by the microspray nozzles 211 to cool down the battery in the box 11; however, doing so is not enough, because heat remains in the box 11, not to mention that the temperature of the battery in the box 11 is on the rise to the detriment of the performance of the battery. It is necessary to remove heat from the box 11 too, by removing hot air from the box 11. To this end, the non-return exhaust duct 14 operates in conjunction with the microspray heat dissipation pipe 13; hence, not only is the cool air delivered to the box 11, but hot air is guided out by the exhaust fan 33 and then removed from the box 11 by the non-return exhaust vent 32, so as to enhance the efficiency of heat exchange of the heat dissipation device for a vehicle battery. The non-return exhaust vent 32 ensures unidirectional flow of the air out of the box 11 and prevents admission of external air (which might carry moisture and dust) to the box 11 through the non-return exhaust duct 14 to contaminate the battery in the box 11.

In an embodiment of the present invention, the rotational speed, start and shutdown of the fan are controlled by a computer or a microcontroller. A temperature sensor, a battery temperature sensor (or battery temperature signals of a battery management system), a temperature-controlled throttle valve, and a control mechanism (not shown) of the exhaust fan operate in conjunction with each other such that the performance of heat dissipation effectuated by the heat dissipation device for a vehicle battery is automatically controlled by a computer or a microprocessor. Depending on how an electric bus is driven, changes are made to the amount of cool air introduced into the heat dissipation device for a vehicle battery, the rotational speed of the exhaust fan, and the number of exhaust fans (if a plurality of exhaust fans is provided), are to start, so as to strike a balance between heat dissipation efficiency and power consumption.

In an embodiment of the present invention, at least one hanging-fixing element is disposed on the outer wall surface of the box to hang the heat dissipation device for a vehicle battery onto the electric bus and facilitate demounting the heat dissipation device for a vehicle battery from the electric bus for a repair thereof and changing the battery. The at least one hanging-fixing element is a ring bolt screwed to the outer wall surface of the box or an equivalent of the ring bolt. In a variant embodiment, a short hole is disposed on the outer wall surface of the box, without reducing the mechanical strength of the box, to hang the heat dissipation device for a vehicle battery onto the electric bus and facilitate demounting the heat dissipation device for a vehicle battery from the electric bus for a repair thereof and changing the battery.

In an embodiment of the present invention, a waterproof, dustproof protective element is disposed between the box and the microspray heat dissipation pipe and between the box and the non-return exhaust duct, which together with a waterproof plastic sheet disposed airtightly between the upper lid and the box, renders the heat dissipation device for a vehicle battery waterproof and dustproof. In an embodiment of the present invention, the heat dissipation device for a vehicle battery is dustproof and waterproof (IP66 or better) to meet the driving requirements of the electric bus.

Therefore, the present invention provides a heat dissipation device for a vehicle battery to receive an electric bus' battery, dissipate heat therefrom, feature a waterproof, dustproof protective mechanism, and ensure that the battery can function reliably and safely. The heat dissipation device for a vehicle battery according to the present invention uses either a built-in air conditioning system of the electric bus or a standalone air conditioning system as the source of cool air and has a dehumidifying mechanism for preventing intrusion of moisture which may otherwise cause the battery to rust or develop a short circuit. The heat dissipation device for a vehicle battery according to the present invention is modularized and can be integrally manufactured in order to be mounted on or demounted from the electric bus, so as for its installation and maintenance to be easy and quick. The heat dissipation device for a vehicle battery according to the present invention is applicable to means of transportation, such as electric buses, electric crane trucks, ships and aircraft, and ensures stable power supply to electric buses and green means of transportation, thereby having high industrial applicability and versatility.

The above embodiments are illustrative of the features and effects of the present invention rather than restrictive of the scope of the substantial technical disclosure of the present invention. Persons skilled in the art may modify and alter the above embodiments without departing from the spirit and scope of the present invention. Therefore, the scope of the protection of rights of the present invention should be defined by the appended claims.

What is claimed is:

1. A heat dissipation device for a vehicle battery, comprising:
a box for receiving therein at least a vehicle battery;
an upper lid disposed above the box and separated from the box by a waterproof plastic sheet;
a microspray heat dissipation pipe disposed on a side of the box and having at least a microspray nozzle in communication with an inside of the box; and
at least a non-return exhaust duct disposed on an opposing side of the box and in communication with the inside of the box.

2. The heat dissipation device for a vehicle battery according to claim 1, wherein the microspray heat dissipation pipe comprises:
a condensation pipe having the at least a microspray nozzle in communication with the inside of the box and having an end in communication with a cool air generation source;
a temperature-controlled throttle valve disposed between the condensation pipe and the cool air generation source; and
an enclosing case for enclosing the condensation pipe.

3. The heat dissipation device for a vehicle battery according to claim 2, wherein the cool air generation source is an air conditioning system of a vehicle.

4. The heat dissipation device for a vehicle battery according to claim 2, wherein the cool air generation source is a standalone air conditioning unit.

5. The heat dissipation device for a vehicle battery according to claim 2, further comprising a dehumidifying unit disposed between the temperature-controlled throttle valve and the cool air generation source.

6. The heat dissipation device for a vehicle battery according to claim 5, wherein the dehumidifying unit takes in moisture with activated carbon.

7. The heat dissipation device for a vehicle battery according to claim 1, wherein the non-return exhaust duct comprises:
an exhaust pipe having an end in communication with the inside of the box and another end provided with a non-return exhaust vent; and
an exhaust fan disposed in the exhaust pipe and positioned proximate to the non-return exhaust vent.

8. The heat dissipation device for a vehicle battery according to claim 1, wherein a hanging-fixing element is disposed on an outer wall surface of the box.

9. The heat dissipation device for a vehicle battery according to claim 8, wherein the hanging-fixing element is a ring bolt.

10. The heat dissipation device for a vehicle battery according to claim 1, wherein a waterproof, dustproof protective element is disposed between the box and the microspray heat dissipation pipe and between the box and the non-return exhaust duct.
